(19) United States
(12) Patent Application Publication
(10) Pub. No.: US 2009/0193450 A1
(43) Pub. Date: Jul. 30, 2009

(54) SIGNAL RECEIVER SECURITY APPARATUS AND METHODS

(75) Inventor: Marcus Kellerman, San Diego, CA (US)

Correspondence Address: Weiss & Arons, LLP, 1540 Route 202, Suite 8, Pomona, NY, 10970, US

(73) Assignee: Broadcom Corporation, Irvine, CA (US)

(21) Appl. No.: 12/020,672

(22) Filed: Jan. 28, 2008

(51) Int. Cl. H04N 7/16

(52) U.S. Cl. 725/25

(57) ABSTRACT

Apparatus and methods for denying a user a benefit of information transmitted to a device. The device may be a satellite signal receiver, which may be in the form of a set-top box, or any other device for which location-based security is desired. The method may include disabling a function of the device if the device is in a location at which the user is not entitled to the benefit. The device location may be determined based on the position of at least one beacon, which may be part of a Global Positioning System satellite.

### FIELD OF THE INVENTION

The present invention relates generally to denial of benefits from transmitted information based on unauthorized use of a device that receives the information.

### BACKGROUND OF THE INVENTION

Direct broadcast satellite services may lose revenue because of “account packing” in association with set-top box resale, which is when a consumer orders more set-top boxes that he intends to use and resells extra set-top boxes. The consumer may “pack” a single account with many set-top boxes (each additional box costs only a small incremental amount) by purporting to require a number of set-top boxes that exceeds the number of televisions in his home. The consumer sells one or more of the excess set-top boxes to another individual for unauthorized, and unremunerated, service consumption in a different location. Set-top box vendors may lose revenues from such sales.

The boxes can be used, in conjunction with a satellite dish and a television, to receive satellite television signals anywhere that the signals are broadcast. It is difficult for the provider of the satellite television signals to determine the locations where the boxes are actually being used. It is also difficult to enforce policies or agreements governing use of the boxes.

One contravention to account packing and resale is to require that a set-top box be wired to a land-based phone service and programmed to dial out from time to time to connect with a system that identifies the location of the set-top box based on caller-ID data associated with the land-based phone service. However, there are a considerable number of consumers that do not have a phone service access point near their set-top boxes or do not have any land-based phone service.

It would therefore be desirable to provide apparatus and methods for detecting and contravening unauthorized use of set-top boxes and the like.

### SUMMARY OF THE INVENTION

It is an object of the invention to provide apparatus and methods for detecting and contravening unauthorized use of set-top boxes and the like. Apparatus and methods for detecting and contravening unauthorized use of devices are therefore provided, substantially as shown in and/or described in connection with at least one of the figures, and as set forth more completely in the claims.

### BRIEF DESCRIPTION OF THE DRAWINGS

The above and other features of the present invention, its nature and various advantages will be more apparent upon consideration of the following detailed description, taken in conjunction with the accompanying drawings, and in which:

FIG. 1 shows apparatus including illustrative apparatus that are in accordance with the principles of the invention;

FIG. 2 shows apparatus (also shown in FIG. 1) in accordance with the principles of the invention;

FIG. 3 shows, in more detail, the apparatus shown in FIG. 2;

FIG. 4 shows an illustrative process in accordance with the principles of the invention;

FIG. 5 shows another illustrative process in accordance with the principles of the invention; and

FIG. 6 shows yet another illustrative process in accordance with the principles of the invention.

### DETAILED DESCRIPTION OF EMBODIMENTS

Apparatus and methods for denying a user a benefit of information transmitted to a device are provided. The benefit may be denied when an attempt is made use the device at a location that is not eligible for the use. The benefit may include receiving information, content, programming, services or any other suitable benefit. The device may be any type of device configured to decode information signals and convert them into a format in which the benefit may be provided to the user. The device may be a satellite signal receiver, which may be in the form of a set-top box, or any other device for which location-based security is desired.

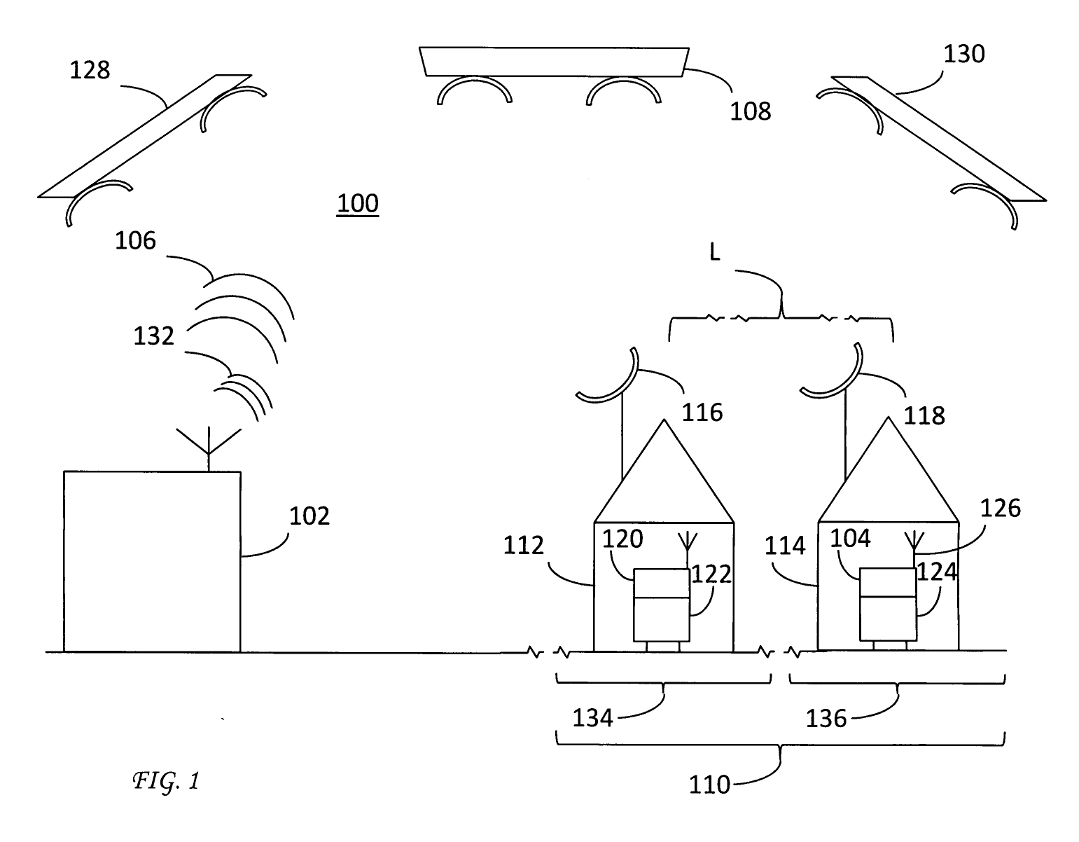

Illustrative features of the invention are described below with reference to FIGS. 1-6. As will be appreciated by one of ordinary skill in the art, features of the invention that are described herein may be embodied as a method, data processing apparatus, a data processing system or a computer program. Accordingly, the features may take the form of an entirely hardware embodiment, an entirely software embodiment or an embodiment combining software and hardware aspects. Furthermore, some features may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

FIG. 1 shows illustrative system 100, in which the benefit of information transmitted by head-end or broadcast station 102 can be denied to a user of device 104. Broadcast station 102, which may be a satellite television signal broadcast station, may broadcast signal 106 to satellite station 108, which may rebroadcast the signal to a region 110, which may include sites 112 and 114, at which users receive signal 106 via antennae 116 and 118, which may have suitable feedhorns (not shown).

Antennae 116 and 118 may transmit signal 106 to devices 120 and 104, respectively. Devices 120 and 104 may process signal 106 and, following processing, may output a signal based on signal 106 to output devices 122 and 124, respectively, which may be any suitable output device, such as a visual or audio output device, such as a display screen or speaker. The users of output devices 122 and 124 receive the benefit of information in signal 106 when they view or hear output from output devices 122 and 124.

If device 104 is present at site 114, but, for example, is eligible for use only at site 112, the use at site 114 may be detected by identifying the location of device 104 using a location-detecting module in, or in communication with, device 104. The location-detecting module may communicate, via antenna 126, for example, with one or more beacons such as one or more of satellites 128 and 130, which are representative of other beacons that may be accessible and may be used to calculate the actual position of device 104 using known methods, such as those used by devices that utilize the Global Positioning System.

The actual location may be compared to site 112, which is the corresponding eligible location. Site 112 may be identified by a mailing address, a residence address, a billing address, geodetic coordinates or any other suitable location identifiers. If the difference between the locations of sites 112 and 114 exceeds a criterion, for example, distance L, which may be predetermined, device 104 may execute a control command that prevents a user at site 114 from receiving the benefit at output device 124 from signal 106.

In some embodiments, device 104 may transmit, via antenna 118, the actual location of device 104 so that comparison between the actual device location and the corresponding eligible location may be performed at broadcast station 102. In such embodiments, broadcast station 102 may transmit disable signal 132 that may instruct device 104 to disable a function of device 104 and thereby prevent a user at site 114 from receiving the benefit at output device 124 from signal 106.

In some embodiments, classes of users may be denied the benefit of information in signal 106. The classes may be based on geographic criteria, such as the distance from a selected location, a group of one or more zip codes, or proximity to a geographic feature such as a river. For example, region 110 may include sub-regions 134 and 136, in which sites 112 and 114 may be situated, respectively. The benefit may be provided only to sites that are in sub-region 134. Sites that are in sub-region 136 may be denied the benefit by transmission of disabling signal 132 to all devices outside of sub-region 134, including device 104. Such an embodiment may be used to deny benefit to devices that are proximal to a live sporting event, for example, to promote local admission ticket sales.

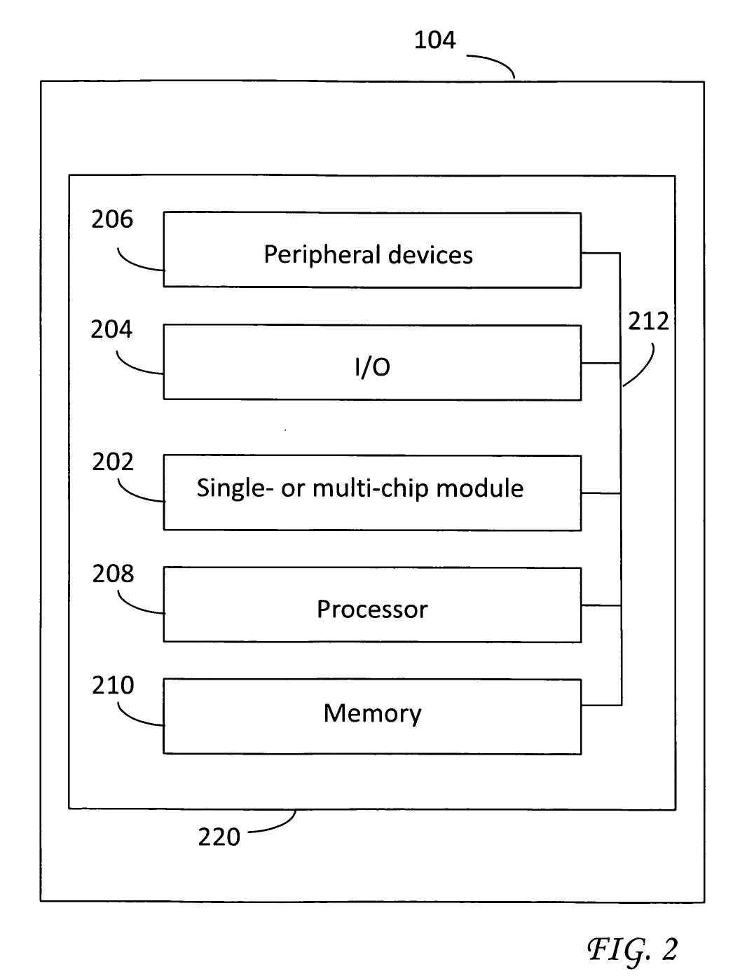

FIG. 2 shows an illustrative embodiment of device 104 (shown in FIG. 1). Device 104 may include single or multi-chip module 202, which can be one or more integrated circuits, and which may include logic configured to: compare differences between actual and eligible locations to distance criteria; compare a location to a set of locations; or to perform any other suitable logical operations. Device 104 may include one or more of the following components: I/O circuitry 504, which may interface with coaxial cable, telephone lines, wireless devices, such as antenna 126 (shown in FIG. 1), output device 124 (shown in FIG. 1), a keypad/display control device or any other suitable media or devices; peripheral devices 206, which may include counter timers, real-time timers, power-on reset generators or any other suitable peripheral devices; processor 208, which may control process flow, and which may enable and disable functionality of other components in device 104; and memory 210. Components 202, 204, 206, 208 and 210 may be coupled together by a system bus or other interconnections 212 and may be present on one or more circuit boards such as 220. In some embodiments, the components may be integrated into a single chip.

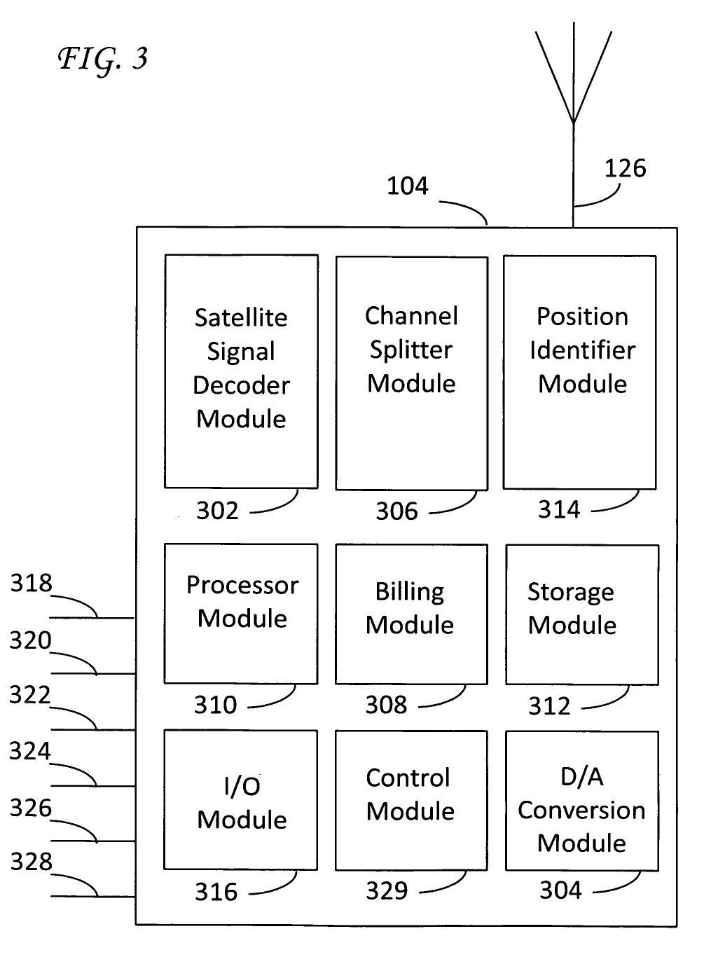

FIG. 3 shows illustrative function-based modules that may be present in device 104 in connection with the hardware components shown in FIG. 2. Device 104 may include satellite signal decoder module 302, which may unscramble signal 106, which may be encrypted using DES (Data Encryption Standard), 3DES (Triple Data Encryption Standard), AES (Advanced Encryption Standard) or any other suitable method of encryption used by set-top box conditional access systems. Module 302 may output digital motion picture data in any suitable compression format, such as MPEG-2, MPEG-4, AVC (Advanced Video Coding), VC1 (a Society of Motion Picture and Television Engineers codec standard) or any other suitable video compression format, to D/A (digital-to-analog) conversion module 304, which may convert the digital motion picture data into an analog data stream that is appropriate for output device 124 (shown in FIG. 1). The analog data stream may conform to the National Television Systems Committee (“NTSC”) format, PAL (Phase Alternating Line), or any other suitable uncompressed video format. Device 104 may include channel splitter module 306, which may split out a user-selected channel of information from signal 106 for analog conversion by conversion module 304. Device 104 may include billing module 308, which may record billing entries associated with pay-per-view broadcast events. Processor module 310 and storage module 312 may correspond to processor 208 and memory 210 (shown in FIG. 2).

Device 104 may include position identifier module 314, which may be in communication with antenna 126 (shown also in FIG. 1), for receiving positioning data from satellites such as 128 and 130 (shown in FIG. 1). In some embodiments, antenna 126 may be in direct communication with input-output (“I/O”) module 316. The positioning data may define the actual location of device 104. Processor module 310 may compare the actual location data with eligible location data, which may be stored in storage module 312. If processor module 310 determines that the actual location is one that is not eligible for service, processor module may deny to a user of device 104 the benefit of information from signal 106 by disabling one or more of the functional modules in device 104. In some embodiments, the benefit may be denied by disabling data communication between one or more of the modules in device 104.

I/O module 316 may be in communication with port 318, which may receive signal 106 from antenna 118 (shown in FIG. 1). I/O module 316 may be in communication with port 320, which may exchange data with a keypad/display device (not shown), which may be used to configure device 104. The keypad/display device may be used to input a location that is eligible for service. I/O module 316 may be in communication with cable port 322, which may exchange content or control data over a coaxial cable-based communication network. The cable-based network may be a cable television network, a MoCA™-based network, or any other suitable electronic communications network. (MoCA is the Multimedia over Coax Alliance, which provides at its website (www.mocalliance.org) an example of a specification (viz., that available under the trademark MoCA, which is hereby incorporated herein by reference in its entirety) for networking of digital video and entertainment information through coaxial cable.) The I/O module may also use DOCSIS (Data Over Cable Service Interface Specification), out of band, or any other upstream communication method.

I/O module 316 may be in communication with port 324, which may exchange content or control data over a pre-existing Internet connection. I/O module 316 may exchange content or control data with a wireless transceiver (not shown) via port 326. The wireless transceiver may operate using Bluetooth, IR, WIFI or any other suitable protocols in order to utilize existing cell phone or network connections that may be available. The content may be any form of audio, video or text content. The control data may include program guide information, program selections, control data for controlling the functionality, or for disabling, device 104, or any other suitable data. I/O module 316 may be in communication with port 328 to output information to output device 124, thereby delivering a benefit of signal 106 to a user of device 104.

Control module 329 may be present to interface between I/O module 316 and other modules present in device 104.

Device 104 may operate in a networked environment supporting connections to one or more remote computers (not shown). The network connections may include a local area network (not shown) and a wide area network (not shown), but may also include other networks. It will be appreciated that the network connections shown are illustrative and other means of establishing a communications link between the computers may be used. The existence of any of various well-known protocols such as TCP/IP, Ethernet, FTP, HTTP and the like is presumed, and device 104 can be operated as a server in a client-server configuration to permit a user to retrieve web pages from device 104. Any of various conventional web browsers can be used to display and manipulate data on web pages.

Device 104 may support the implementation of computer executable instructions for invoking user functionality related to communication, such as email, short message service (SMS), and voice input and speech recognition applications.

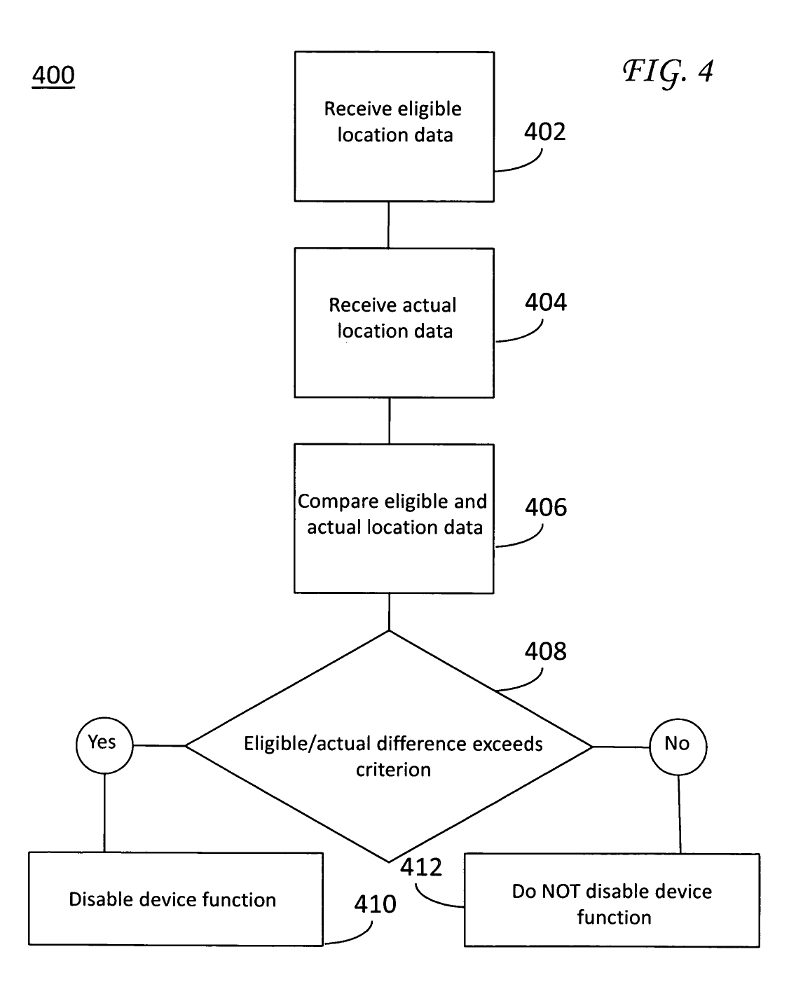

FIGS. 4-6 show illustrative processes that may be performed by the apparatus shown in FIGS. 1-3. One of ordinary skill in the art will appreciate that the steps illustrated in the figures may be performed in other than the recited order and that one or more steps illustrated may be optional. The methods and systems of the above-referenced embodiments may also include other additional elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

FIG. 4 shows illustrative process 400, that in some embodiments may be performed by device 104 and in some embodiments may be performed at broadcast station 102. At step 402, eligible location data are received. Eligible location data indicate a location at which a user is eligible to receive a benefit from signal 106 (shown in FIG. 1). At step 404, actual location data are received. The actual location data may be generated by position identifier module 314 (shown in FIG. 3). At step 406, the eligible and actual location data are compared. Step 406 may be performed by device 104. In some embodiments, step 406 may be performed by broadcast station 102, which may receive actual location data from device 104. At step 408, a difference between the eligible location and the actual location is tested against a criterion such as distance L (shown in FIG. 1). In some embodiments, step 408 may be performed by broadcast station 102. If the difference exceeds L, a function of device 104 may be disabled in step 410. If the difference does not exceed L, the function is not disabled, in step 412. In embodiments in which step 410 is performed by broadcast station 102, step 410 may include transmitting disable signal 132 (shown in FIG. 1) from broadcast station 102.

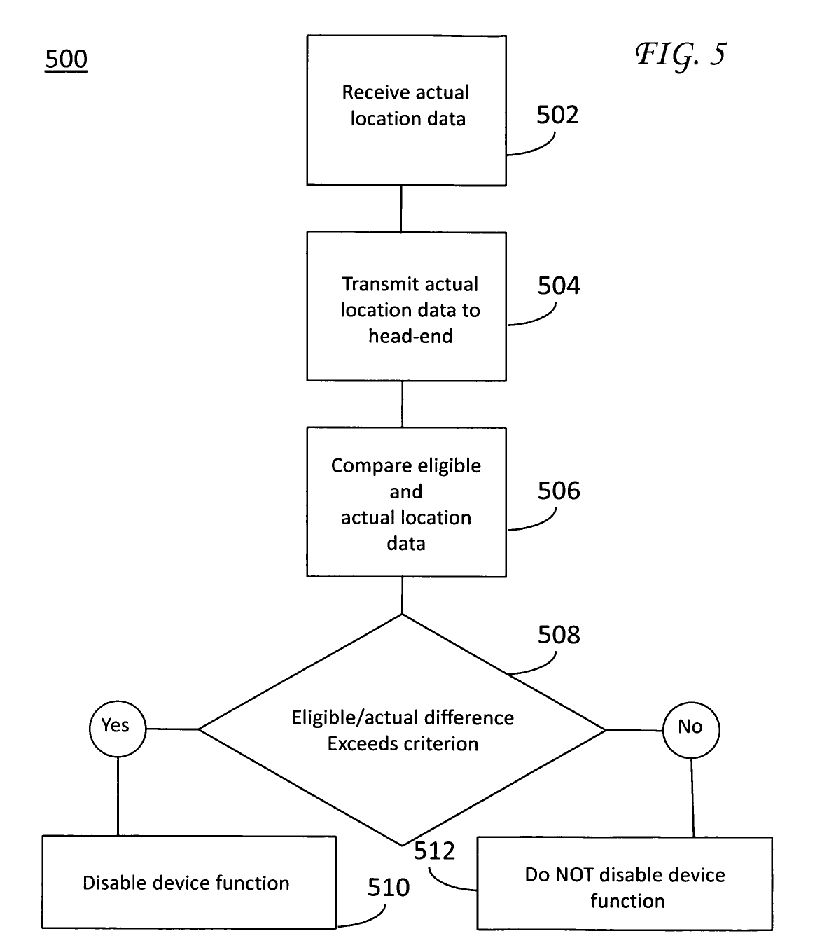

FIG. 5 shows illustrative process 500, that may be performed by device 104 (shown in FIG. 1). In step 502, device 104 may receive actual location data via position identifier module 314. In step 504, device 104 may transmit the actual location data to broadcast station 102 (shown in FIG. 1). Steps 506, 508, 510 and 512 correspond to steps 406, 408, 410 and 412 (shown in FIG. 4).

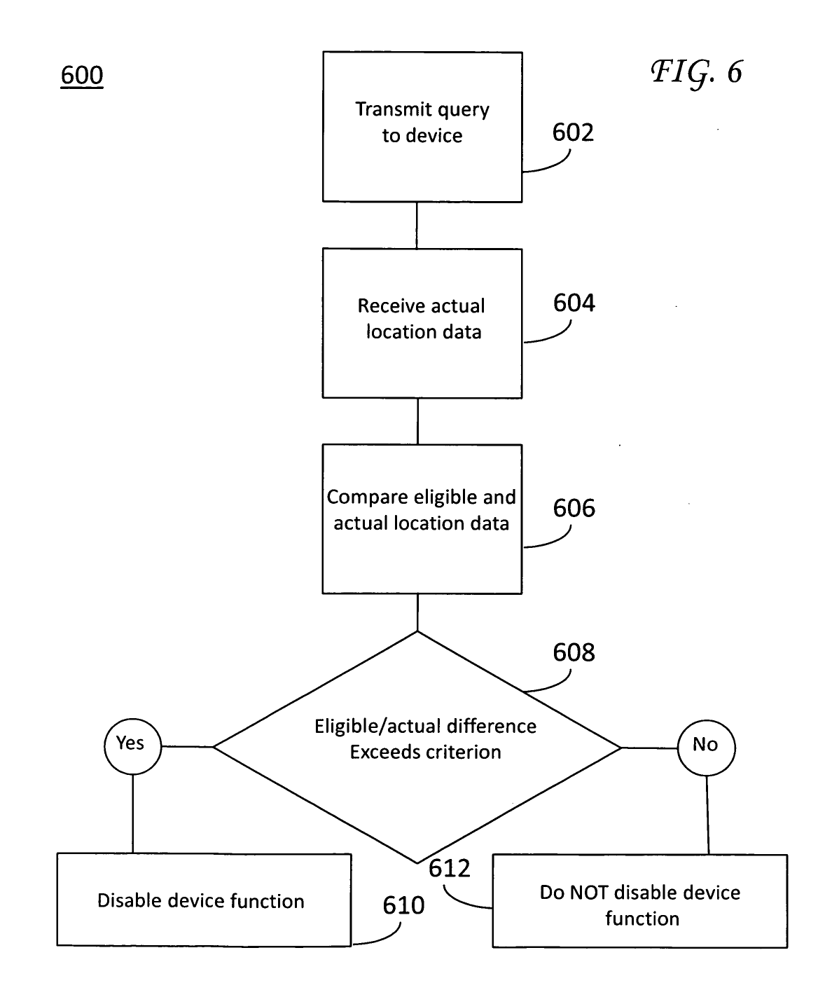

FIG. 6 shows illustrative process 600, that may be performed by broadcast station 102 (shown in FIG. 1). In step 602, broadcast station 102 may transmit a location query to device 104. In response to the query, device 104 may, via identifier module 314, obtain actual location data and transmit the actual location data to broadcast station 102, where steps 606, 608, 610 and 612, which correspond to steps 406, 408, 410 and 412 (shown in FIG. 4) may be performed as appropriate.

As described above, and shown in the FIGS., embodiments of the invention include apparatus and methods for denying a user a benefit of information transmitted to a device. Embodiments of the invention are further described below.

A method in accordance with the principles of the invention may include determining the location of the device based on the position of at least one beacon, which may be part of a Global Positioning System satellite. The determining may include receiving positioning data using a radio receiver. The radio receiver may be collocated with an output device, which may be a television, configured to deliver the benefit. The radio receiver may be collocated with an antenna for receiving the information. The method may include disabling a function of the device if the device is in a location at which the user is not entitled to the benefit.

When the location of the device is a first location, the method may include comparing the first location to a second location. The second location may be a location at which the user is entitled to receive the benefit. The disabling may include testing if the first and second locations differ by more than a critical distance. The comparing may include identifying a portion of a mailing address that corresponds to the second location. The comparing may include identifying a portion of a residence address that corresponds to the second location. The comparing may include identifying information that corresponds to geodetic coordinates of the second location.

The method may include receiving data corresponding to the second location and storing the received data in memory in communication with the device. The receiving may include manually inputting the data into the memory. The manual inputting of data may occur when the device is deployed at the second location. Alternatively, the receiving may include manually inputting the data into the memory before the device is deployed at the second location, for example, at a retail point-of-sale. The receiving may include distributing the location to one or more additional devices, via a communication network or any other suitable manner.

A method in accordance with the principles of the invention may include transmitting to a head-end an identifier of the first location. In such embodiments, the disabling may include receiving a disable signal that was transmitted, if the first location differs from a second location by more than a critical distance, at the head-end; and the second location may be a location at which the user is entitled to receive the benefit. In some embodiments, the location may have an eligibility to receive the benefit. The eligibility may be based on admission ticket sales for an event. The transmitting to the head-end may include applying a digital watermark to an outbound signal. The head-end may interpret the watermark to identify the first location. The transmitting to the head-end may be scheduled, unscheduled, periodic, at randomly chosen time intervals or on the basis of any other suitable scheme.

In some embodiments of the invention, a method may include transmitting from a satellite television broadcasting head-end a disabling signal configured to disable a function of the device if, at the location, the user is not entitled to the benefit. If the location is a first location, such a method may include testing if the first location and a second location differ by more than a critical distance, as described above with respect to the other embodiments. The second location may be a location at which the user is entitled to receive the benefit. The testing may be performed at the head-end. Alternatively, the testing may be performed at the first location.

In certain embodiments, a method may include transmitting from the head-end data indicative of the critical distance. Such embodiments may also compare the first location to the second location by identifying a portion of a mailing address that corresponds to the second location. The comparing may include identifying a portion of a residence address that corresponds to the second location. The comparing may include identifying information that corresponds to geodetic coordinates of the second location.

In some embodiments of the invention, a method may include querying the device with a query signal that triggers the device to transmit the data. Such a method may include activating a location-dependent disabling function in the device. The method may also include deactivating a location-dependent disabling function in the device.

In yet other embodiments of the invention, the method may include receiving, at the head-end, from the device, data indicating a location. The location may be a geographic region in which there is a class of users that is not entitled to receive the benefit. The class may have an eligibility to receive the benefit. The eligibility may be based on admission ticket sales for an event.

As described above, an apparatus in accordance with the principles of the invention may be configured for denying a user a benefit of information transmitted by a transmitter. In some embodiments of the invention, the apparatus may include an interface that receives the information from an antenna and transmits the information to the user via an output device; and a processor that disables the interface if the apparatus is in a location at which the user is not entitled to receive the benefit. The apparatus may include a positioning module that determines the location based on at least one beacon, which may be operatively integrated with a satellite that is part of the Global Positioning System. The apparatus may include a transmitter that transmits the location to a head-end.

When the location of the device is a first location, the apparatus may include memory that stores a second location. A user at the second location may be entitled to receive the benefit at the second location. The apparatus may include a comparator module in communication with the memory and the processor. The comparator may be configured to perform a test of the distance between the first location and the second location; and communicate to the processor a result of the test. The comparator may be configured to test whether the location is in a set of locations that are either eligible or ineligible for delivery of the benefit.

It will be appreciated that software components of the present invention including programs and data may, if desired, be implemented in ROM (read only memory) form, including CD-ROMs, EPROMs and EEPROMs, or may be stored in any other suitable computer-readable medium such as but not limited to discs of various kinds, cards of various kinds and RAMs. Components described herein as software may, alternatively, be implemented wholly or partly in hardware, if desired, using conventional techniques.

Thus, apparatus and methods for detecting and contravening unauthorized use of devices are therefore provided. Persons skilled in the art will appreciate that the present invention can be practiced using embodiments of the invention other than those described, which are presented for purposes of illustration rather than of limitation. The present invention is limited only by the claims which follow.

What is claimed is:

1. A method for denying a user a benefit of information transmitted to a device, the method comprising disabling a function of the device if the device is in a location at which the user is not entitled to the benefit.

2. The method of claim 1 further comprising inputting data corresponding to the location into memory in communication with the device.

3. The method of claim 2 wherein the inputting comprises determining the location based on the position of at least one beacon.

4. The method of claim 3 further comprising, when the location is a first location, comparing the first location to a second location, the second location being a location at which the user is entitled to receive the benefit;
wherein the disabling comprises testing if the first and second locations differ by more than a critical distance.

5. The method of claim 4 further comprising manually inputting data corresponding to the second location into the memory when the device is deployed at the location.

6. The method of claim 5 wherein the determining comprises receiving positioning data using a radio receiver.

7. The method of claim 6 wherein the receiving comprises receiving a signal from a Global Positioning System satellite.

8. The method of claim 3 further comprising, when the location is a first location, transmitting to a head-end an identifier of the first location;
wherein:
the disabling comprises receiving a disable signal transmitted, if the first location differs from a second location by more than a critical distance, by the head-end; and
the second location is a location at which the user is entitled to receive the benefit.

9. The method of claim 8 wherein the transmitting comprises applying a digital watermark to an outbound signal, the digital watermark comprising the identifier.

10. The method of claim 1 further comprising transmitting to a head-end an identifier of the location;
wherein the disabling comprises receiving a disable signal transmitted, if the location is not eligible for delivery of the benefit, by the head-end.

11. The method of claim 10 wherein the transmitting comprises applying a digital watermark to an outbound signal, the digital watermark comprising the identifier.

12. The method of claim 10 wherein the location has an eligibility to receive the benefit, the eligibility being based on admission ticket sales for an event.

13. Apparatus for denying a user a benefit of information transmitted by a transmitter, the apparatus comprising:
an interface that receives the information from an antenna and transmits the information to the user via an output device; and
a processor that disables the interface if the apparatus is in a location at which the user is not entitled to receive the benefit.

14. The apparatus of claim 13 further comprising a positioning module that determines the location based on at least one beacon.

15. The apparatus of claim 14 wherein the beacon is a satellite that is part of the Global Positioning System.

16. The apparatus of claim 14 further comprising a transmitter that transmits the location to a head-end.

17. The apparatus of claim 13 further comprising, when the location is a first location, memory that stores a second location;
wherein:
the user is entitled to receive the benefit at the second location; and
the memory is in communication with the interface.

18. The apparatus of claim 17 further comprising a comparator module in communication with the memory and the processor, the comparator module configured to:
perform a test of the distance between the first location and the second location; and
communicate to the processor a result of the test.

19. The apparatus of claim 13 further comprising a comparator module in communication with the processor, the comparator module configured to:
perform a test of the membership of the location in a set of locations that are ineligible for delivery of the benefit; and
communicate to the processor a result of the test.

20. The apparatus of claim 13 further comprising a comparator module in communication with the processor, the comparator module configured to:
perform a test of the membership of the location in a set of locations that are eligible for delivery of the benefit; and
communicate to the processor a result of the test.

21. The apparatus of claim 13 wherein the interface and the processor are included in a set-top box.
